(19) United States
(12) Patent Application Publication
(10) Pub. No.: US 2022/0085584 A1
(43) Pub. Date: Mar. 17, 2022

(54) SUPPORT MEMBER ASSEMBLY

(71) Applicant: W. L. GORE & ASSOCIATES GMBH, PUTZBRUNN (DE)

(72) Inventor: Rudolf Reichert, Pleinfeld (DE)

(21) Appl. No.: 17/422,651

(22) PCT Filed: Jan. 17, 2019
(86) PCT No.: PCT/US2019/014003

§ 371 Date: Jul. 13, 2021

(51) Int. Cl. H02G 3/04; F16G 13/16; F16L 3/015

(52) U.S. Cl. CPC H02G 3/04; F16L 3/015; F16G 13/16

(57) ABSTRACT

A support member includes a flexible member and a plurality of support elements linearly attached to the flexible member, each support element including first and second contact portions, the support elements being positioned on the flexible member such that the first contact portion of each support element faces the second contact portion of a corresponding adjacent support element. The support member is movable between a straight configuration in which the first contact portion of each support element is received in the second contact portion of the corresponding support element such that the first contact portion and the second contact portion cooperate to restrict bending of the support member in a first direction, and a curved configuration in which the first contact portion of each support element and the second contact portion of the corresponding support element are spaced apart to permit the flexible member to bend in a second direction.

### TECHNICAL FIELD

The present invention relates to the field of flexible supports. In particular, the invention is directed to flexible supports for use with conductors designed to transmit electromagnetic energy and/or conduits that carry gasses or fluids. The flexible supports described herein provide a wide range of motion in one direction, while limiting sag, torsion and/or shear stress. The invention is also directed to assemblies incorporating the flexible supports.

### BACKGROUND

The desire to have movable ribbon cables and other assemblies of electrical conductors, optical conductors, or pneumatic conduits in industrial machinery lead to the development of flexible supports for the assemblies. One type of flexible support is based on mechanical interlocking designs referred to as “cable tracks.” Cable tracks are made of a linear series of interlocking segments that partially surround and cradle a group of conductors or conduits. The interlocking segments often have surface features that interact to confine the range of motion of the cable tracks and the associated conductors or conduits to prevent excessive bending or kinking of the conductors or conduits. In some applications, the motion of a cable track ranges between a flattened configuration and a configuration that bends in only one direction. Cable tracks are limited in many applications by their bulky size, weight, large bend radius, mechanical vibration, power consumption, and rapid wear. In some applications, such as manufacturing in a clean room environment, wear of the cable track material often produces particulates that contaminate the work area or work product.

As an alternative, flexible support members made of motion-limiting elements fixed to a flexible material have been developed. Similar to the interlocking segments, these support materials have a wide range of motion in one direction, but are restricted in an opposite direction. The support member can be incorporated into an assembly of conductors and cables. In addition, a supported assembly has applications for machines that perform rapid and precise mechanical movements over long periods of time. There continues to be a need for improved support members that are easier to manufacture and are durable.

### SUMMARY

Covered embodiments are defined by the claims, not this summary. This summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

An exemplary embodiment of the present disclosure relates to a support member, including an elongated flexible member and a plurality of support elements linearly attached to the elongated flexible member along a length thereof, each support element including a first contact portion and a second contact portion, the support elements being positioned on the elongated member such that the first contact portion of each support element faces the second contact portion of a corresponding adjacent support element. The support member is movable between: (i) a first straight configuration in which the first contact portion of each support element is received in the second contact portion of the corresponding adjacent support element such that the first contact portion of each support element and the second contact portion of the corresponding adjacent support element cooperate to restrict bending and torsion the support member in a first direction, and (ii) a second curved configuration in which the first contact portion of each support element and the second contact portion of the corresponding adjacent support element are spaced apart from one another to permit the elongated flexible member to bend in the first direction, wherein the first contact portion of each support element is a projection having a first face and a second face meeting at a first angle of between 80 degrees and 100 degrees, and wherein the second contact portion of each support element is a recess having a third face and a fourth face meeting at a second angle of between 80 degrees and 100 degrees.

In an embodiment, the first angle and the second angle are equal.

In an embodiment, when the first and second faces are projected on to a plane parallel to the longitudinal axis of the body and perpendicular to a plane encompassing the elongated flexible member, the first and second faces form a triangle with a base connecting respective ends of the first and second faces.

In an embodiment, the first and second faces meet at an edge opposite the base.

In an embodiment, when the third and fourth faces are projected on to a plane parallel to the longitudinal axis of the body and perpendicular to a plane encompassing the elongated flexible member, the third and fourth faces form a triangle with a base connecting respective ends of the third and fourth faces.

In an embodiment, the third and fourth faces meet at an edge opposite the base.

In an embodiment, the projection spans at least 50% of a width of the support element.

In an embodiment, the recess spans at least 50% of a width of the support element.

In an embodiment, each of the plurality of support elements is attached to a same side of the flexible member.

In an embodiment, the flexible member includes a plurality of holes for attaching to the plurality of support elements.

In an embodiment, the flexible member comprises a metal.

In an embodiment, the first angle is 90 degrees.

In an embodiment, the second angle is 90 degrees.

In an embodiment, the first contact portion spans at least 80% of a width of the support element.

In an embodiment, the second contact portion spans at least 80% of a width of the support element.

In an embodiment, the first contact portion spans an entire width of the support element.

In an embodiment, the second contact portion spans an entire width of the support element.

In an embodiment, the flexible member comprises a polymer.

In an embodiment, at least one of the plurality of support elements comprises a metal.

In an embodiment, at least one of the plurality of support elements comprises a polymer.

Another exemplary embodiment of the present disclosure relates to a support system, including a first mount, a second mount, and a support member extending from a first end coupled to the first mount to a second end coupled to the second mount, the support member comprising: an elongated flexible member and a plurality of support elements linearly attached to the elongated flexible member along a length thereof, each support element including a first contact portion and a second contact portion, the support elements being positioned on the elongated flexible member such that the first contact portion of each support element faces the second contact portion of a corresponding adjacent support element, wherein the support member is movable between: (i) a first straight configuration in which the first contact portion of each support element is received in the second contact portion of the corresponding adjacent support element such that the first contact portion of each support element and the second contact portion of the corresponding adjacent support element cooperate to restrict bending of the support member in a first direction, and (ii) a second curved configuration in which the first contact portion of each support element and the second contact portion of the corresponding adjacent support element are spaced apart from one another to permit the elongated flexible member to bend in the first direction, wherein the first contact portion of each support element is a projection having a first face and a second face meeting at a first angle of between 80 degrees and 100 degrees, and wherein the second contact portion of each support element is a recess having a third face and a fourth face meeting at a second angle of between 80 degrees and 100 degrees.

### BRIEF DESCRIPTION OF THE DRAWINGS

FIG. 1 is a schematic diagram of a cable towing system having mounts and a support member, in accordance with some embodiments.

FIG. 2 is a perspective view of a portion of the support member of FIG. 1 including a plurality of support elements, in accordance with some embodiments.

FIG. 3 is another perspective view of a portion of the support member of FIG. 1 including the plurality of support elements and an elongated flexible member, in accordance with some embodiments.

FIG. 4 is a side view of the support member of FIG. 1 in a straight configuration, in accordance with some embodiments.

FIG. 5 is a side view of the support member of FIG. 1 in a curved configuration, in accordance with some embodiments.

FIG. 6 is a perspective view of exemplary support elements and elongated flexible member of the support member of FIG. 1, in accordance with some embodiments.

FIG. 7 is a perspective view of an exemplary support element of the support member of FIG. 1, in accordance with some embodiments.

### DETAILED DESCRIPTION

Persons skilled in the art will readily appreciate that various aspects of the present disclosure can be realized by any number of methods and apparatus configured to perform the intended functions. It should also be noted that the accompanying figures referred to herein are not necessarily drawn to scale, but may be exaggerated to illustrate various aspects of the present disclosure, and in that regard, the drawing figures should not be construed as limiting.

As discussed in detail below, the support member of the present disclosure can support an assembly of conductors, conduits, cables, channels or other components. The support member comprises an elongated flexible member having a plurality of support elements fixed to the elongated flexible member. In the present embodiments, the support member does not have joints or mechanical interlocking segments to connect adjacent support elements. Thus, because there are no mechanically interlocking pieces that cause friction, the embodiments of the present invention reduce particulate accumulation and increase the durability of the support member.

One challenge of a support member without joints or interlocking support elements is that the support member may have sag when supporting the load of the assembly, including its weight. As the assembly becomes longer, this challenge becomes more difficult. To overcome this challenge, the support members disclosed herein have support elements which contact each other when the assembly is in a horizontal, or straight, configuration to provide torsion control of the support member. The contact between adjacent support elements may maintain the length of the support member in a taut configuration and reduce shrinking, stretching, sagging or deformation that would lead to problems in supporting the load.

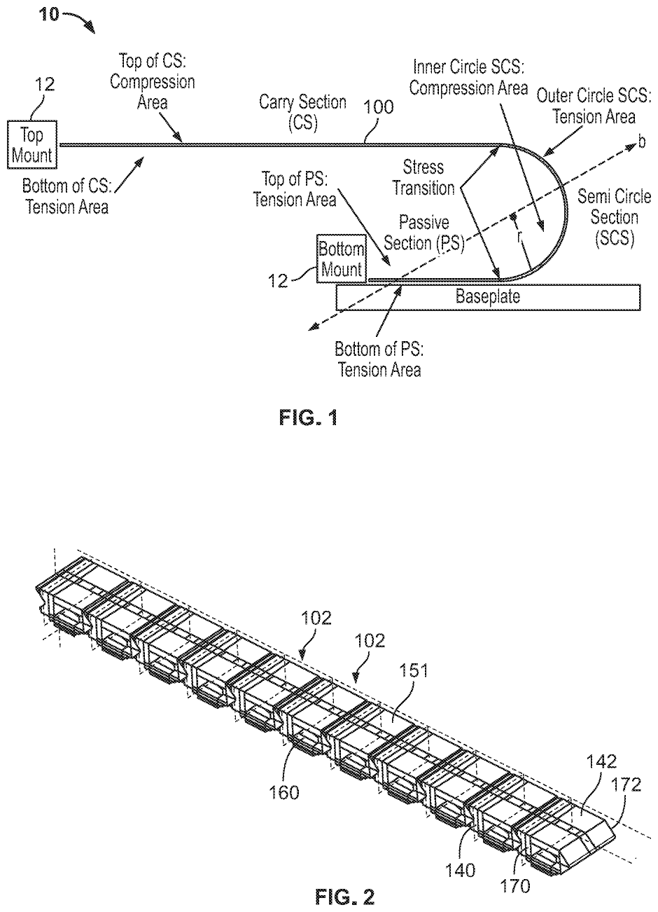

In some embodiments, the support member allows bending in one direction. For example, in one embodiment, the support elements define a minimum bend radius about bend axis b, depicted in FIG. 1, and limit the bending in an opposite direction. The minimum bend radius refers to the radius of the support member when bent to its fullest extent in one direction. The support member may bend in the desired direction and the bending is limited by the interaction of the support elements. In particular, the minimum bend radius is limited when contact portions of adjacent support elements contact each other, as will be described in further detail below. For longer assemblies, having a range of motion is particularly useful.

The assembly may be repeatedly bent and stretched while limiting dust and while protecting conductors, conduits, and cables. The assemblies exhibit excellent fatigue resistance to repeated bending achieved by the support members disclosed herein.

In addition, the support members provide torsion control to limit twisting or kinking of the support member and the assembly into which the support member is incorporated. When used in longer applications, the torsion on the support member creates excess movement or stress out of the radial bending plane in multiple directions, including the x-direction, the y-direction and the z-direction. The assembly may be moved along its length in the x-direction, side-to-side in the y-direction or up and down in the z-direction. The movement may be rapid, which can further increase the stress and torsion on the assembly. However, in some embodiments described herein, the torsion is limited by the support elements. In some embodiments described herein, torsion is limited by projections on the support elements. Limiting torsion may improve the lifespan and durability of the support member.

FIGS. 1-2 show a cable towing assembly 10 comprising a support member 100 having a plurality of support elements 102 fixed to an elongated flexible member 104. The support elements 102, in this embodiment, are linearly attached to the elongated flexible member 104 along a length thereof. The number of support elements 102 arranged in a longitudinal direction depends on the length of the assembly and, in some embodiments, can vary from 10 to 1000 units. In some embodiments, the number of support elements 102 is between 100 and 900. In other embodiments, the number of support elements is between 200 and 800. In other embodiments, the number of support elements is between 400 and 700. In other embodiments, the number of support elements is between 500 and 600. In other embodiments, the number of support elements is between 50 and 500. In other embodiments, the number of support elements is between 100 and 200.

Cable towing assemblies 10 are often used in industrial plants with linear process paths as a support system for cables and hoses. In some embodiments, the assembly 10 connects equipment (not shown), such as semiconductor processing equipment, and does not include any joints along its length. However, the assembly 10 is still flexible so that the assembly 10 can bend in one direction about the bend axis b. The support member 100 restricts bending in other directions and advantageously reduces sagging, shear tension, as well as torsion. In an embodiment, the assembly 10 is held in position via at mounts or clamps 12. As shown in FIG. 1, in some embodiments, the clamps 12 are positioned at either end of the towing assembly 10. In other embodiments, the assembly 10 includes clamps 18 positioned at regular or irregular intervals along a length thereof.

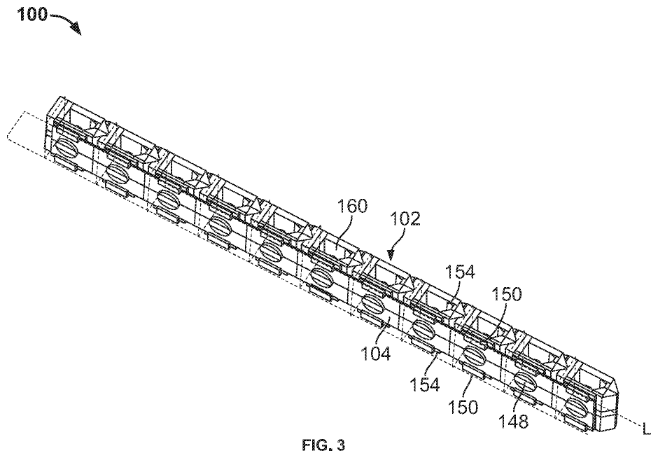

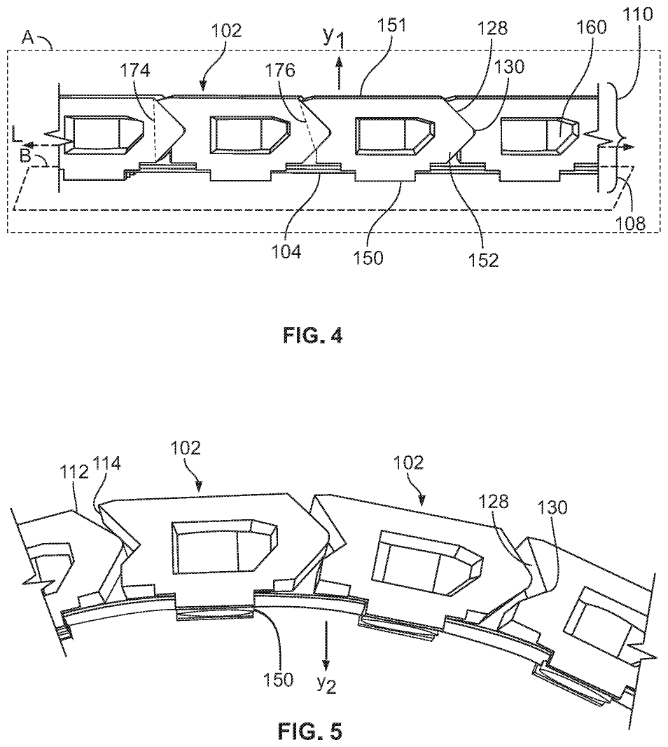

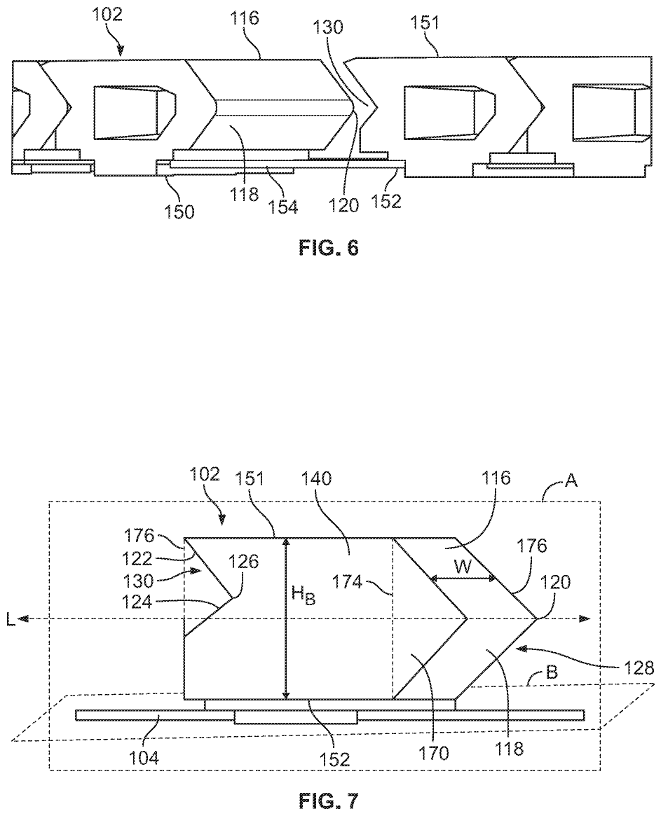

As depicted in FIGS. 2-6, the support members 100 include the plurality of support elements 102 fixed to the elongated flexible member 104. The support elements 102 comprise a coupling portion 108 and a body 110. The elongated flexible member 104 fixed to the support elements 102 at the coupling portion 108, as shown in FIGS. 3-4. In some embodiments, the coupling portion 108 is mounted on the elongated flexible member 104 by over molding the support element 102. In some embodiments, the coupling portion 108 comprises two longitudinal extensions 150 extending from a first face 152 of the support element 102 closes to the elongated flexible member 104. The extensions 150 each have a recess 154 (as best seen in FIG. 6) extending longitudinally therethrough. The recesses 154 are sized and shaped to receive the elongated flexible member 104 therethrough such that the extensions are “hooked” around lateral edges of the elongated flexible member 104, as shown in FIG. 3. In other embodiments, a pin or fastener 148 fixes the support element 102 and elongated flexible member 104 together by extending through holes in the elongated flexible member 104, as shown in FIG. 3.

In some embodiments, the coupling portion 108 and the body 110 are integrated and have a unitary construction. By being integrated, the coupling portion 108 and the body 110 are not formed separately and are not separable. This construction reduces the assembly steps and does not require separately connecting the coupling portion 108 to the elongated flexible member 104 or using another member such as a post fixed to the elongated flexible member 104 for mounting the regions thereto. Having integrated regions above and below the elongated flexible member 104 may make the assembly process steps faster and easier. In addition, the integrated structure of the support element 102 may provide for more rigidity for the support member 100.

In other embodiments, the coupling portion 108 and the body 110 comprises separate components that are assembled together to form the support element 102. For example, the body 110 may be formed (i.e., by over molding, etc.) on the elongated flexible member 104 and the coupling portion 108 is mounted thereto to form the support elements 102. In this embodiment, a fastener 148 such as a screw or pin is used to connect the coupling portion 108 and the body 110 together.

In some embodiments, the body 110 of each support element 102 is substantially cuboidal or rectangular in shape and extends along a central longitudinal axis from a first end to a second opposing end. The body 110 includes a first surface 151 and second parallel surface 152 connected by a first side surface 140 and a parallel second side surface 142, as best seen in FIGS. 4-6. The first end comprises a first contact portion 112 and the second end comprises a second contact portion 114. Thus, in an assembled configuration, the first contact portion 112 of each support element 102 face the second contact portion 114 of a corresponding adjacent support element 102. The first and second contact portions 112, 114 of corresponding adjacent support elements 102 are configured to cooperate with each other in a straight configuration (depicted in FIG. 4) to restrict bending of the support member 100 in a first direction Y₁, as will be described in further detail below.

In an exemplary embodiment, the first contact portion 112 of each support element 102 includes a projection 128 extending from the first end of the body 110, as shown in FIGS. 4-7. The projection 128 includes a first face 116 and a second face 118 which are perpendicular to the first and second side surfaces 140, 142 and angled toward the central longitudinal axis L relative to the first and second surfaces 151, 152 to meet at an edge 120. As shown in FIG. 2, the projection 128 further includes a first side 170 extending along or parallel to a plane including the first side surface 140 of the body 110 and a second side 172 extending along or parallel to a plane including the second side surface 142 of the body such that the first and second sides 170, 172 are parallel to one another. FIGS. 4 and 5 show a portion of the support member 100 when viewed in a plane A parallel to the longitudinal axis L of the body 110 and perpendicular to a plane B encompassing the elongated flexible member 104. When the first and second faces 116, 118 are projected onto the plane A, as depicted in FIGS. 4 and 7, they form a triangle together with a base 174 connecting respective ends of the first and second faces 116, 118 that are opposite the edge 120. In an embodiment, the first and second faces 116, 118 define an angle between 80 degrees and 100 degrees. In another embodiment, the first and second faces 116, 118 define an angle between 45 degrees and 90 degrees. In another embodiment, the first and second faces 116, 118 define an angle between 60 and 80 degrees. In another embodiment, the first and second faces 116, 118 define an angle of 90 degrees.

In some embodiments, the projection 128 spans at least 50% of the width of the support element 102. The support element width W is defined as a distance measured perpendicular to the longitudinal axis L of the support element 102 between the two parallel side surfaces 140, 142 of the support element 104, as shown in FIG. 7. In other embodiments, the projection 128 spans at least 60% of the width of the support element 102. In other embodiments, the projection 128 spans at least 70% of the width of the support element 102. In other embodiments, the projection 128 spans at least 80% of the width of the support element 102. In other embodiments, the projection 128 spans at least 90% of the width of the support element 102. In other embodiments, the projection 128 spans 100% of the width of the support element 102.

In some embodiments, the projection 128 spans at least 75% of the height of the body 110 of the support element 102. The body height HB is defined as a distance measured perpendicular to the longitudinal axis L of the support element 102 between parallel first and second surfaces 151, 152 of the support element body 114, as best seen in FIGS. 6-7. In other embodiments, the projection 128 spans at least 80% of the height of the support element 102. In other embodiments, the projection 128 spans at least 85% of the height of the support element 102. In other embodiments, the projection 128 spans at least 90% of the width of the support element 102. In other embodiments, the projection 128 spans at least 95% of the height of the support element 102. In other embodiments, the projection 128 spans 100% of the height of the support element 102.

The second contact portion 114 of each support element 102, in an exemplary embodiment, includes a recess 130 extending into the body 110 from the second end of the body 110, as shown in FIGS. 4 and 7. The second contact portion 114 has a profile corresponding the profile of the first contact portion 112 such that the recess 130 receives the projection 128. Specifically, the recess 130 encloses the first and second faces 116, 118 of the projection 128 of the corresponding adjacent support element 102. For example, the second contact portion 114 includes a first face 122 and a second face 124 which are perpendicular to the first and second side surfaces 140, 142 and angled toward the central longitudinal axis L relative to the first and second surfaces 151, 152 to meet at an edge 126. The edge 126 extends parallel to the plane B encompassing the elongated flexible member 104. As can be seen in FIGS. 4 and 7, in an exemplary embodiment, when the first and second faces 122, 124 are projected on the plane A, the first and second faces 122, 124 form a triangle with a base 176 connecting the respective ends of the first and second faces 122, 124, opposite the edge 126. In an embodiment, the first and second faces 116, 118 define an angle between 80 degrees and 100 degrees. In another embodiment, the first and second faces 116, 118 define an angle between 45 degrees and 90 degrees. In another embodiment, the first and second faces 116, 118 define an angle between 60 and 80 degrees. In another embodiment, the first and second faces 116, 118 define an angle of 90 degrees.

The width (i.e., a dimension extending perpendicular to the longitudinal axis L of the support element 102 between the two lateral faces 140, 142 of the support element 104) of the recess 130 is substantially equal to the width of the projection 128 of the corresponding adjacent support element 104. For example, in embodiments where the projection 128 spans 50% of the width of the support element 102, the recess 130 will span 50% of the width of the support element 102. Furthermore, the recess 130 is positioned on the support element 102 such that the edge 126 of the recess 130 is substantially aligned with the edge 120 of the projection 128. In some embodiments, the recess 130 spans at least 50% of the width of the support element 102. In other embodiments, the projection 128 spans at least 60% of the width of the support element 102. In other embodiments, the recess 130 spans at least 80% of the width of the support element 102. In other embodiments, the recess 130 spans at least 80% of the width of the support element 102. In other embodiments, the recess 130 spans at least 90% of the width of the support element 102. In other embodiments, the recess 130 spans 100% of the width of the support element 102.

The first contact portions 112 and the second contact portions 114 are configured to provide large-scale contact between adjacent corresponding support elements 102 when in the straight configuration, as shown in FIGS. 2-4. This large surface area interface between support elements 102 allows torsion moment of the support elements 102 to be transmitted at the contact portions 112, 114. Furthermore, an enlarged contact area between the support elements 102 results in less pressure at the contact portions 112, 114 per unit area and thus, there is less deformation of the support member 100. That is, with two plane areas touching, such as, for example, first faces 116, 122 and second faces 118, 124, pressure is spread over the entire contact area between the two first faces 116, 122. Additionally, planar contact areas are more tolerant with respect to dirt or other inaccuracies that may affect the system 10. An increased width of the projections 128 and corresponding recesses 130 also allow for the transfer of the moment of stiffness from one support element 102 to another corresponding support element 102. Thus, projections 128 and corresponding recesses 130 that span the entire width of the support elements 102 provide a more stable interface for the transfer of moment of stiffness between the support elements 102.

The projections 128 of the support elements 102 are received within the recesses 130 of the adjacent corresponding support elements 102 but are not interconnected, fixed or locked into the recess. This free connection allows the projections 128 to move freely as the support member 100 is bent, as shown in FIG. 5. In one embodiment, the support elements 102 are separable from each other without needing to disconnect or reconfigure the support member 100, allowing the support members 100 and, in particular, the support elements 102, to be replaced if damaged or worn.

The support member 100 is movable between the straightened configuration, depicted in FIGS. 2-4, and the curved configuration, depicted in FIG. 5. In the straightened configuration, the first contact portion 112 of each support element 102 is received in the second contact portion 114 of a corresponding adjacent support element 102 such that the first contact portion 112 of each support element 102 and the second contact portion 114 of the corresponding adjacent support element 102 cooperate to restrict bending of the support member 100 in the first direction Y₁, as shown in FIG. 5. Specifically, the projection 128 of the first contact portion 112 is inserted into the recess 130 of the second contact portion 114, building a large connection without tolerance from one support element 102 to the next. Furthermore, radial bend is restricted by mechanical properties of the elongated flexible member 104. For, example, the radial bend is constrained by the elastic range of the elongated flexible member 104.

In the curved configuration, the first contact portion 112 of each support element 102 and the second contact portion 114 of the corresponding adjacent support element 102 are spaced apart from one another to permit the elongated flexible member 104 to bend in the second direction Y₂. To avoid self-locking, the angles of the projection 128 and the recess 130 (preferably between 80-100 degrees) may be adjusted depending on the friction coefficient of the support element material. In other words, if the angles of the projection 128 and the recess 130 are larger than the friction coefficient (friction angle) of the support element material, self-locking may be limited. If self-locking is avoided, an easy opening and closing of the connection between the first and second contact portions 112, 114 is enabled. Thus, the support elements 102 are movable between the straight configuration and the bent configuration.

In one embodiment, the maximum radial bend of the support member 100 is shown in FIG. 1. A plurality of support elements 102 are arranged in the longitudinal direction on the elongated flexible member 104. The minimum bend radius refers to the tightest radius (r) possible when bending the support member 100 in one direction, resulting in the maximum radial bend, as depicted in FIG. 1. The radius is tight when the contact portions 112, 114 of adjacent corresponding support elements 102 are spaced apart from each other, thus defining the maximum radial bend. In some embodiments, the minimum bend radius is 40 mm. In other embodiments, the minimum bend radius is between 70 and 80 mm. In other embodiments, the minimum bend radius is 100 mm. In other embodiments, the minimum bend radius is 200 mm. In other embodiment, the minimum bend radius is 300 mm. In other embodiments, the minimum bend radius is 400 mm. In other embodiments, the minimum bend radius is 500 mm.

In an exemplary embodiment, the support elements 102, including the coupling portion 108 and the body 110, have a length (i.e., a dimension extending from the edge 120 of the first contact portion 112 to the second end) between 50 cm and 400 cm. In another embodiment, the support elements 102 have a length between 100 cm and 400 cm. In another embodiment, the support elements 102, have a length between 150 cm and 300 cm. In another embodiment, the support elements 102, have a length between 160 cm and 200 cm.

In an exemplary embodiment, the support elements 102 have a width (i.e., a dimension between lateral faces of the support element 102) between 15 mm and 45 mm. In another embodiment, the support elements 102 have a length between 15 mm and 40 mm. In another embodiment, the support elements 102, have a length between 30 mm and 45 mm. In another embodiment, the support elements 102, have a length between 20 mm and 30 mm.

In some embodiments, the elongated flexible member 104 is a strip or similar piece of material having a uniform width and thickness. The width of the elongated flexible member 104, in an exemplary embodiment, is between 11 mm and 41 mm. In another embodiment, the width of the elongated flexible member 104 is between 15 mm and 35 mm. In another embodiment, the width of the elongated flexible member 104 is between 15 mm and 30 mm. In another embodiment, the width of the elongated flexible member 104 is between 16 mm and 26 mm. In an embodiment, the width of the elongated flexible member 104 is less than a width of the support elements 102. In another embodiment, the width of the elongated flexible member 104 is greater than a width of the support elements 102. In this embodiment, the elongated flexible member 104 is connected to the support elements 102 by the pin or fastener 148 extending through the holes in the elongated flexible member 104. The thickness of the elongated flexible member 104, in an embodiment, is between 0.1 mm and 0.7 mm. In another embodiment, the thickness of the elongated flexible member is between 0.2 and 0.5 mm. In another embodiment, the thickness of the elongated flexible member is between 0.3 and 0.4 mm. In another embodiment, the thickness of the elongated flexible member is between 0.4 and 0.6 mm. In an embodiment, the elongated flexible member 104 is elongated in the horizontal direction with a substantially rectangular perimeter.

In an embodiment, the elongated flexible member 104 comprises a plurality of filaments or fibers. In some embodiments, the filaments or fibers are spaced apart and aligned in a planar configuration, e.g., a parallel alignment. In some embodiments, the filaments or fibers are encapsulated by a polymeric coating. In some embodiments, a combination of a strip of material and filaments or fibers is used as the elongated flexible member 104.

In some embodiments, the elongated flexible element 104 comprises metallic or polymeric materials. In some embodiments, metallic materials include, but are not limited to, stainless steel, carbon steel, spring steel, nickel and titanium alloys. In some embodiments, polymeric materials include, but are not limited to, polyester, thermoplastic polyamide such as nylon, polyolefins, polyurethane, polystyrene, polyvinyl chloride, fluoropolymers, fluorothermoplastics, natural and synthetic rubbers, aramid fibers such as KEVLAR® brand fiber, fiberglass, or composite reinforcements thereof. The elongated flexible member 104 can include composites of a metallic and polymeric material.

In some embodiments, the support elements 102 comprise a variety of materials such as metals, polymers, or combinations thereof. In some embodiments, metallic and polymeric materials have high compression resistance and good impact resistance. Consequently, the materials are robust, light in weight, inexpensive, and easy to shape or form. Examples of suitable metallic materials include, but are not limited to, aluminum, brass, zinc, magnesium, and alloys of these materials. In some embodiments, metals are zinc-based alloys with differing amounts of aluminum and small amounts of copper and magnesium. These alloys are available from Eastern Alloys, Inc., Maybrook, N.Y., under the tradename ZAMACK™ as part numbers ZA-8, ZA-12 and ZA-27. Suitable polymeric materials include, but are not limited to, engineered thermoplastics such as p-hydroxybenzoic acid-6 hydroxy-s-naphthoic acid copolymer, commonly referred to as liquid crystal polymer (LCP), glass filled LCP, glass filled nylon and polypropylene, acrylonitrile butadiene styrene (ABS), carbon filled and thermosets such as epoxy and made from fibers etc. from the materials outlined above and other composite materials. An exemplary liquid crystal polymer is available from Polyplastics Co., Ltd., Osaka, Japan, under the tradename VECTRA® liquid crystal polymer. The solids are made by molding, casting, carving, and/or stamping. An exemplary method of heat injection is over-molding, also commonly referred to as insert molding.

In one embodiment, the support element 102 is fixed to the elongated flexible member 104 by directly mounting the support element 102 on the elongated flexible member 104 by an over molding technique. In an embodiment, the elongated flexible member 104 is maintained in a curved configuration in a mold to provide space between each support element 102 as the body 110 of the support elements 102 are formed and attached to the elongated flexible member 104. In some embodiments, as shown in FIGS. 2-4, the support elements 102 have one or more cavities 160. These cavities reduce the weight of the support member 100 but provide a sufficiently thick wall to cure the plastic material when injection molding is used and reduce volumetric shrinkage of the polymer.

Various modifications and additions can be made to the exemplary embodiments of the disclosed treatment systems discussed without departing from the scope of the present invention. While the embodiments described above refer to particular features, the scope of the invention also includes embodiments having different combinations of features and embodiments that do not include all of the above described features. It will be appreciated that features of the various embodiments and examples described herein may be combined with one another in any suitable combination and that the disclosed embodiments are not limiting. For example, features in one embodiment may optionally be imported into another embodiment if it is possible to do so.

1. A support member, comprising:
an elongated flexible member; and
a plurality of support elements linearly attached to the elongated flexible member along a length thereof,
wherein each support element includes a first contact portion and a second contact portion,
wherein the plurality of support elements are positioned on the elongated flexible member such that the first contact portion of each support element faces the second contact portion of a corresponding adjacent support element, wherein the support member is movable between:
(i) a first straight configuration in which the first contact portion of each support element is received in the second contact portion of the corresponding adjacent support element such that the first contact portion of each support element and the second contact portion of the corresponding adjacent support element cooperate to restrict bending of the support member in a first direction and to restrict torsion of the support member, and
(ii) a second curved configuration in which the first contact portion of each support element and the second contact portion of the corresponding adjacent support element are spaced apart from one another to permit the elongated flexible member to bend in a second direction,
wherein the first contact portion of each support element is a projection having a first face and a second face meeting at a first angle of between 80 degrees and 100 degrees, and
wherein the second contact portion of each support element is a recess having a third face and a fourth face meeting at a second angle of between 80 degrees and 100 degrees.

2. The support member of claim 1, wherein the first angle and the second angle are equal.

3. The support member of claim 1, wherein, when the first face and the second face are projected on to a plane parallel to a longitudinal axis of the support member and perpendicular to a plane encompassing the elongated flexible member, the first face and the second face form a triangle with a base connecting respective ends of the first face and the second face.

4. The support member of claim 3, wherein the first face and the second face meet at an edge opposite the base.

5. The support member of claim 1 , wherein when the third face and the fourth face are projected on to a plane parallel to a longitudinal axis of the support member and perpendicular to a plane encompassing the elongated flexible member, the third face and the fourth face form a triangle with a base connecting respective ends of the third face and the fourth face.

6. The support member of claim 5, wherein the third face and the fourth face meet at an edge opposite the base.

7. The support member of claim 1, wherein the projection spans at least 50% of a width of each of the plurality of support elements.

8. The support member of claim 1, wherein the recess spans at least 50% of a width of each of the plurality of support elements.

9. The support member of claim 1, wherein each of the plurality of support elements is attached to a same side of the elongated flexible member.

10. The support member of claim 1, wherein the elongated flexible member includes a plurality of holes for attaching to the plurality of support elements.

11. The support member of claim 1, wherein the elongated flexible member comprises a metal.

12. The support member of claim 1, wherein the first angle is 90 degrees.

13. The support member of claim 1, wherein the second angle is 90 degrees.

14. The support member of claim 1, wherein the first contact portion spans at least 80% of a width of each of plurality of the support elements.

15. The support member of claim 1, wherein the second contact portion spans at least 80% of a width of each of the plurality of support elements.

16. The support member of claim 1, wherein the first contact portion spans an entire width of each of the plurality of support elements.

17. The support member of claim 1, wherein the second contact portion spans an entire width of each of the plurality of support elements.

18. The support member of claim 1, wherein the elongated flexible member comprises a polymer.

19. The support member of claim 1, wherein at least one of the plurality of support elements comprises a metal or a polymer.

20. (canceled)

21. A support system, comprising:
a first mount;
a second mount;
a support member extending from a first end coupled to the first mount to a second end coupled to the second mount, the support member comprising:
an elongated flexible member; and
a plurality of support elements linearly attached to the elongated flexible member along a length thereof,
wherein each support element includes including a first contact portion and a second contact portion,
wherein the plurality of support elements are being positioned on the elongated flexible member such that the first contact portion of each support element faces the second contact portion of a corresponding adjacent support element,
wherein the support member is movable between:
(i) a first straight configuration in which the first contact portion of each support element is received in the second contact portion of the corresponding adjacent support element such that the first contact portion of each support element and the second contact portion of the corresponding adjacent support element cooperate to restrict bending of the support member in a first direction and to restrict torsion of the support member, and
(ii) a second curved configuration in which the first contact portion of each support element and the second contact portion of the corresponding adjacent support element are spaced apart from one another to permit the elongated flexible member to bend in a second direction,
wherein the first contact portion of each support element is a projection having a first face and a second face meeting at a first angle of between 80 degrees and 100 degrees, and
wherein the second contact portion of each support element is a recess having a third face and a fourth face meeting at a second angle of between 80 degrees and 100 degrees.
